(19) United States
(12) Patent Application Publication
(10) Pub. No.: US 2007/0112871 A1
(43) Pub. Date: May 17, 2007

(54) Method and apparatus for facilitating condition-based dynamic auditing policies in a database

(76) Inventors: Gopal Bhimachar Mulagund, Bangalore (IN); Daniel ManHung Wong, Sacramento, CA (US)

Correspondence Address: ORACLE INTERNATIONAL CORPORATION;c/o PARK, VAUGHAN & FLEMING LLP, 2820 FIFTH STREET, DAVIS, CA, 95618-7759, US

(21) Appl. No.: 11/282,496

(22) Filed: Nov. 17, 2005

(51) Int. Cl. G06F 17/30

(52) U.S. Cl. 707/200

(57) ABSTRACT

One embodiment of the present invention provides a system that facilitates dynamically auditing database operations. During operation, the system receives a current database operation. The system checks to see if an audit system contains an audit policy. If so, the system compares the current session properties for a user against the audit policy and determines if the current session properties match the audit policy. If so, the system audits the current session.

### BACKGROUND

1. Field of the Invention

The present invention relates to databases. More specifically, the present invention relates to a method and apparatus for facilitating condition-based dynamic auditing policies in a database.

2. Related Art

An auditing tool provides a powerful mechanism that facilitates both enforcing security policies, and system evaluation. A database administrator can use an auditing tool to detect inappropriate and malicious behavior, and to identify the culprit behind such activities. Similarly, auditing tools can help database administrators detect flaws in system design, as well as make potential improvements to the design.

Typically, auditing is a binary process; either auditing is active or it is not. If auditing is active, audit logs can become very expensive because of the large amount of space required to store the audit logs, as well as the resources used to conduct the audit. Furthermore, the larger the audit logs become, the more time a database administrator may need to review the audit logs. Moreover, the larger the audit logs become, the more difficult it potentially becomes for the database administrator to identify important information. This can result in an increased chance that the database administrator will overlook an important piece of information.

If auditing is not active, however, it is easier for intrusions and malicious behavior to go undetected. Furthermore, without auditing, it is much more difficult for the database administrator to collect information that can be used to improve system performance.

Hence, what is needed is a more flexible auditing system for a database which is less affected by the problems listed above.

### SUMMARY

One embodiment of the present invention provides a system that facilitates dynamically auditing database operations. During operation, the system receives a current database operation. The system checks to see if an audit system contains an audit policy. If so, the system compares the current session properties for a user against the audit policy and determines if the current session properties match the audit policy. If so, the system audits the current session.

In a variation of this embodiment, the process of comparing the current session properties against the audit policy can be initiated by a stored procedure, a condition based on the application context, or an event trigger.

In a variation of this embodiment, the audit system can be either an integrated component within the system, or an external component associated with the system. Alternatively, the audit system can be comprised of both an integrated component and an external component.

In a variation of this embodiment, the audit policy includes session properties for determining when auditing should occur, and an identifier for a database schema to be audited.

In a further variation, session properties can include: a time of day; an authentication method; an Internet Protocol address; a client program; a username; a department; a responsibility; a position; and any other audit-determining session property.

In a further variation, the database schema to be audited can include: a database operation beyond the current database operation for the user; a database operation beyond the current database operation for a set of users; the current database operation for the user; and any other database schema that can be audited.

In a variation of this embodiment, upon auditing the current session, the method further involves executing a secondary procedure associated with the audit policy, wherein executing the secondary procedure can involve sending an alert to a mobile device, or any other additional necessary actions.

In a variation of this embodiment, the audit policy defines multiple levels of auditing, wherein the audit level which is ultimately selected depends on properties of the current session.

### BRIEF DESCRIPTION OF THE FIGURES

FIG. 1 illustrates a computing environment in accordance with an embodiment of the present invention.

FIG. 2 illustrates the structure of a number of audit policies in accordance with an embodiment of the present invention.

FIG. 3 presents a flowchart illustrating the creation of an audit policy in accordance with an embodiment of the present invention.

FIG. 4 presents a flowchart illustrating operation of a system in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Overview

One embodiment of the present invention provides a method and apparatus for facilitating condition-based dynamic auditing policies in a database. Typically, auditing is a binary process; either auditing occurs, or it does not. The present invention allows for more flexible auditing procedures. In doing so, the present invention allows a user to have greater granularity of control over what is audited.

In one embodiment of the present invention, when a database receives a database operation, the system determines if an applicable audit policy exists. To determine this, the system compares audit policies to the current session properties. If a match is found, the system enforces the audit policy. If not, auditing does not occur.

In one embodiment of the present invention, the system can check for the existence of an audit policy after a user-defined number of database operations instead of after every database operation.

The audit policy can be as simple as auditing everything, or it can be more complex. For example, the audit policy can include instructions to audit the next twenty-five database operations.

In one embodiment of the present invention, the audit policy can involve executing a secondary procedure associated with the audit policy. For example, an audit policy can execute a procedure that sends an alert to a database administrator's cellular phone.

In one embodiment of the present invention, an audit policy can be kept active even after the audit conditions are no longer true.

In one embodiment of the present invention, an audit policy can define multiple levels of auditing. The auditing level can be selected based upon the current session properties.

In one embodiment of the present invention, the method is facilitated by adding extensions to the structured query language (SQL). For example, these extensions can be defined by the following syntax: “AUDIT <privilege/statement/operation on an object> BY <user(s)/ALL> WHEN <system state>”; “CALL <Procedure>”; and “KEEP <audit_policy>”.

Note that some existing audit systems provide for audit policies based on objects being accessed, privileges being used, and operations being performed (apart from session properties). In contrast, the present invention can also utilize session properties in addition to objects being accessed, privileges being used, and operations being performed.

Computing Environment

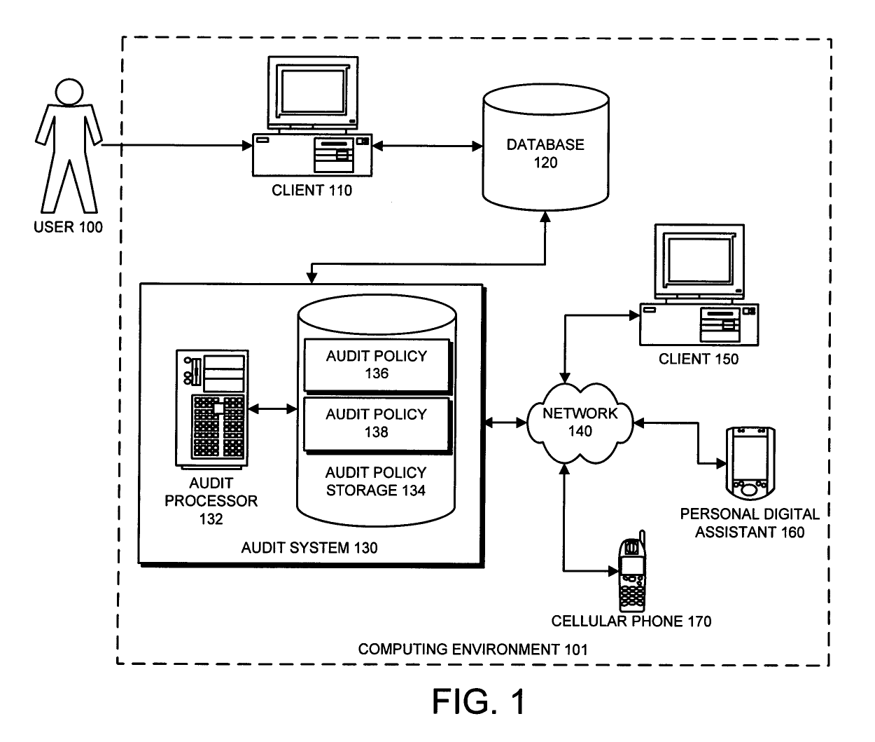

FIG. 1 illustrates a computing environment 101 in accordance with an embodiment of the present invention. Computing environment 101 can generally include any type of computer system, including, but not limited to, a computer system based on a microprocessor, a mainframe computer, a digital signal processor, a portable computing device, a personal organizer, a device controller, and a computational engine within an appliance. Computing environment 101 is operated by user 100 who uses client 110 to interact with database 120. Database 120 interacts with audit system 130 which in turn interacts with network 140. Audit system 130 includes audit processor 132 and audit policy storage 134. Audit policy storage 134 includes audit policy 136 and audit policy 138. Audit policy storage 134 can be any other type of storage system. Network 140 interacts with client 150, personal digital assistant 160, and cellular phone 170.

Clients 110 and 150 can generally include any node on a network including computational capability and including a mechanism for communicating across the network.

Database 120 can include any type of system for storing data in non-volatile storage. This includes, but is not limited to, systems based upon magnetic, optical, and magneto-optical storage devices, as well as storage devices based on flash memory and/or battery-backed up memory.

Network 140 can generally include any type of wired or wireless communication channel capable of coupling together computing nodes. This includes, but is not limited to, a local area network, a wide area network, or a combination of networks. In one embodiment of the present invention, network 140 includes the Internet.

Audit system 130 can be any type of system that performs auditing of a user, schema, or database operation. Note that audit system 130 may or may not be contained within the primary database system.

During operation, client 110 sends a database operation request from user 100 to database 120. Upon receipt of the database operation request, database 120 contacts audit system 130 to determine if auditing should occur, and if so, what audit policy to enforce.

Audit system 130 then examines audit policies 136 and 138, wherein audit policies 136 and 138 have been defined by a database administrator and stored in audit policy storage 134. If audit system 130 determines that the current session properties match that defined in either audit policy 136 or audit policy 138, then audit system 130 audits database 120 in a manner consistent with the matching audit policy.

In one embodiment of the present invention, executing an audit policy involves calling a procedure which may involve interacting with client 150, personal digital assistant 160 or cellular phone 170.

In a further embodiment of the present invention, interacting with client 150, personal digital assistant 160 or cellular phone 170 may involve communicating across network 140.

Audit Policy

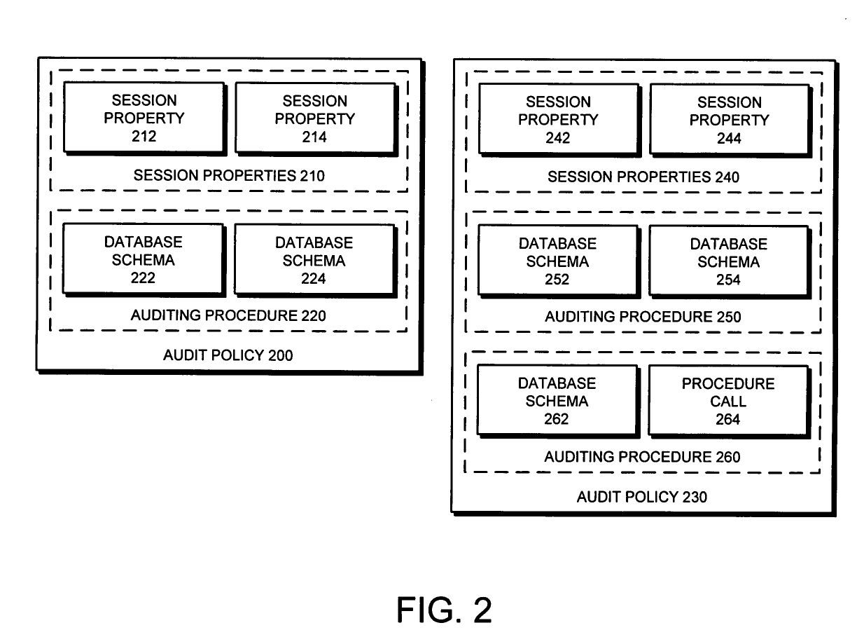

FIG. 2 illustrates the structure of a number of audit policies in accordance with an embodiment of the present invention. An audit policy is made up of session properties which are used to determine if the audit policy should be enforced, and auditing procedures which define what should be audited and for how long auditing should occur.

More specifically, audit policy 200 is defined by session properties 210, and auditing procedure 220, wherein session properties 210 includes session property 212 and 214, and auditing procedure 220 includes database schema 222 and 224. Similarly, audit policy 230 is defined by session properties 240, and auditing procedures 250 and 260, wherein session properties 240 includes session property 242 and 244, and auditing procedure 250 includes database schema 252 and 254. Auditing procedure 260 similarly includes database schema 262 and procedure call 264.

In the example as illustrated in FIG. 2, audit policy 200 contains a single auditing procedure. However, in another example, audit policy 230 contains multiple auditing procedures.

In one embodiment of the present invention, an auditing procedure can include a procedure call as exemplified by auditing procedure 260 and procedure call 264. Procedure call 264 can involve executing a local procedure, or a remote procedure. Session properties 210 and 240 can include any session property that can be measured or examined by an audit system.

Creating an Audit Policy

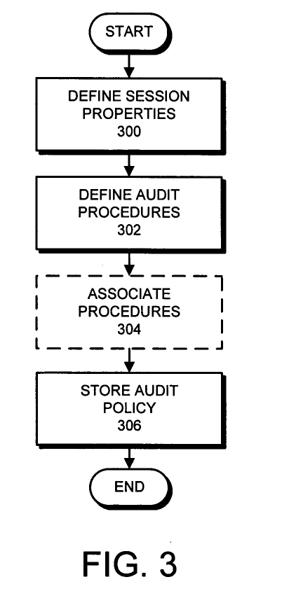

FIG. 3 presents a flowchart illustrating the creation of an audit policy in accordance with an embodiment of the present invention. The process begins with an administrator defining what session properties should be used to decide if the audit policy should be executed (step 300). The administrator then defines audit procedures to be executed if the audit policy session properties match the session properties of the current session (step 302).

Optionally, the administrator associates procedure calls as part of the audit procedures (step 304). An example of an optional procedure call is a procedure call that results in an alert being sent to a mobile device owned by the administrator. The administrator then specifies a location in which to store the newly defined or newly amended audit policy (step 306).

System Operation

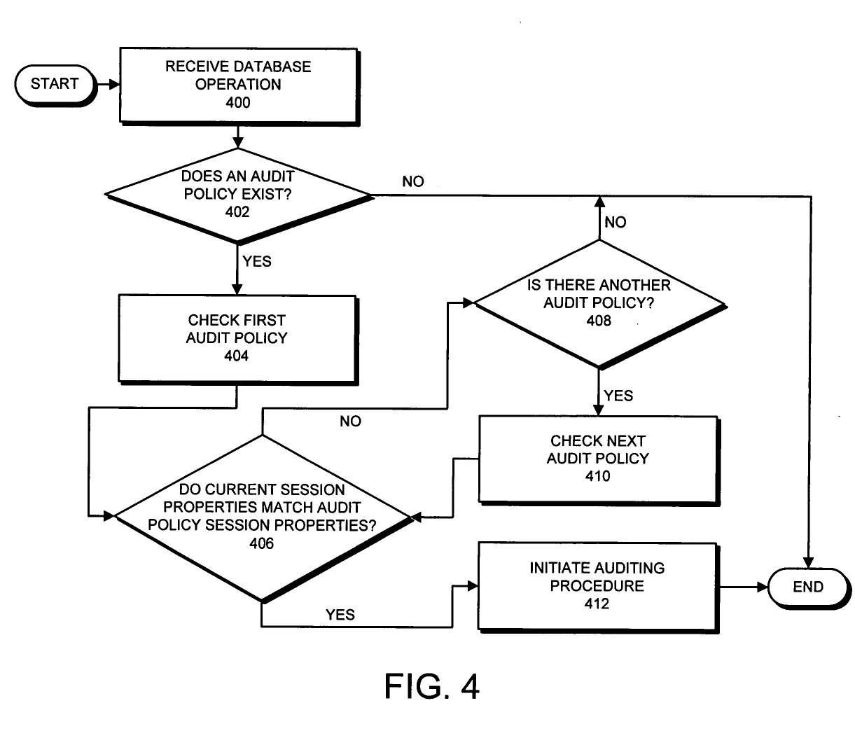

FIG. 4 presents a flowchart illustrating operation of a system in accordance with an embodiment of the present invention. The process begins with the system receiving a database operation (step 400). The audit system then checks to see if an audit policy exists (step 402). If so, the audit system retrieves the first audit policy (step 404). If not, auditing does not occur.

The audit system then compares the audit policy's session properties with the session properties of the current session to determine if they match (step 406). If so, the audit system initiates the auditing procedure (step 412). If not, the system checks to see if another audit policy exists (step 408). If so, the audit system retrieves the next audit policy (step 410) and returns to step 406 to repeat the process. If not, auditing does not occur.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for dynamically auditing database operations comprising:
receiving a current database operation at a database;
checking an audit system for an audit policy;
if the audit policy is found, comparing current session properties for a user against the audit policy to determine if the current session properties match the audit policy; and
if so, auditing the current session.

2. The method of claim 1, wherein the process of comparing current session properties for the user against the audit policy can be initiated by one of:
a stored procedure;
a condition based on application context; and
an event trigger.

3. The method of claim 1, wherein the audit system can be one of:
an integrated component within the database;
an external component associated with the database; and
a combination of an integrated component, and an external component.

4. The method of claim 1, wherein the audit policy includes:
session properties for determining when auditing should occur; and
an identifier for a database schema to be audited.

5. The method of claim 4, wherein session properties can include:
a time of day;
an authentication method;
an Internet Protocol address;
a client program;
a username;
a department;
a responsibility;
a position; and
any other audit-determining session property.

6. The method of claim 4, wherein the database schema to be audited can include:
a database operation beyond the current database operation for the user;
a database operation beyond the current database operation for a set of users;
the current database operation for the user; and
any other database schema that can be audited.

7. The method of claim 1, wherein upon auditing the current session, the method further involves executing a secondary procedure associated with the audit policy, wherein the secondary procedure can involve sending an alert to a mobile device, or performing any other additional necessary actions.

8. The method of claim 1, wherein the audit policy defines multiple levels of auditing, wherein the level of auditing which is ultimately selected depends on the current session properties.

9. A computer-readable storage medium storing instructions that when executed by a computer cause the computer to perform a method for dynamically auditing database operations the method comprising:
receiving a current database operation at a database;
checking an audit system for an audit policy;
if the audit policy is found, comparing current session properties for a user against the audit policy to determine if the current session properties match the audit policy; and
if so, auditing the current session.

10. The computer-readable storage medium of claim 9, wherein the process of comparing current session properties for the user against the audit policy can be initiated by one of:
a stored procedure;
a condition based on application context; and
an event trigger.

11. The computer-readable storage medium of claim 9, wherein the audit system can be one of:
an integrated component within the database;
an external component associated with the database; and
a combination of an integrated component, and an external component.

12. The computer-readable storage medium of claim 9, wherein the audit policy includes:
session properties for determining when auditing should occur; and
an identifier for a database schema to be audited.

13. The computer-readable storage medium of claim 12, wherein session properties can include:
a time of day;
an authentication method;
an Internet Protocol address;
a client program;
a username;
a department;
a responsibility;
a position; and
any other audit-determining session property.

14. The computer-readable storage medium of claim 12, wherein the database schema to be audited can include:
a database operation beyond the current database operation for the user;
a database operation beyond the current database operation for a set of users;
the current database operation for the user; and
any other database schema that can be audited.

15. The computer-readable storage medium of claim 9, wherein upon auditing the current session, the method further involves executing a secondary procedure associated with the audit policy, wherein the secondary procedure can involve sending an alert to a mobile device, or performing any other additional necessary actions.

16. The computer-readable storage medium of claim 9, wherein the audit policy defines multiple levels of auditing, wherein the level of auditing which is ultimately selected depends on the current session properties.

17. An apparatus for implementing dynamic auditing at a database comprising:
a database;
an audit system;
a receiving mechanism within the database configured to receive a current database operation at the database;
a retrieval mechanism configured to check the audit system for an audit policy;
an evaluation mechanism to determine if a current session's properties match the audit policy's session properties; and
an auditing mechanism configured to audit the database if the current session's properties match the audit policy's session properties.

18. The apparatus of claim 17, wherein the audit system can be one of:
an integrated component within the database;
an external component associated with the database; and
a combination of an integrated component, and an external component.

19. The apparatus of claim 17, wherein the auditing mechanism is further configured to execute a secondary procedure associated with the audit policy, wherein the secondary procedure can involve sending an alert to a mobile device, or performing any other additional necessary actions.

20. The apparatus of claim 17, wherein the auditing mechanism is further configured to perform multiple levels of auditing.
